(19) United States
(12) Patent Application Publication
(10) Pub. No.: US 2023/0419411 A1
(43) Pub. Date: Dec. 28, 2023

(54) SYSTEM AND METHOD FOR DETERMINING AND PROVIDING TUITION ENROLLMENT INSURANCE

(71) Applicant: RiskClimate, Inc., Kalamazoo, MI (US)

(72) Inventors: David L. Anderson, Kalamazoo, MI (US); Neil Edward Carlson, Grand Rapids, MI (US); Annette Hofmann, Cincinnati, OH (US)

(21) Appl. No.: 18/207,873

(22) Filed: Jun. 9, 2023

Related U.S. Application Data
(60) Provisional application No. 63/355,691, filed on Jun. 27, 2022.

(51) Int. Cl. G06Q 40/08; G06Q 30/0202; G06Q 30/0204

(52) U.S. Cl. CPC G06Q 40/08; G06Q 30/0202; G06Q 30/0205

(57) ABSTRACT

Systems and methods for providing tuition enrollment insurance for institutions of higher education (IHEs). The tuition enrollment insurance can be based upon parametric analytic triggers. The systems and methods can provide a tuition enrollment insurance data input interface, statistical modeling, visual analytics, a user selection interface, and a monitoring interface for tracking compliance and results.

### BACKGROUND OF THE INVENTION

The present invention relates to computer systems and methods for determining and providing coverage for tuition enrollment insurance.

The single biggest risk faced by Institutions of Higher Education (IHEs) is unexpectedly steep and sudden changes in enrollment. Despite major sources of risk such as demographic change, economic volatility, and geopolitical instability affecting flows of prospective students, no meaningful enrollment insurance product is readily available to IHEs. Enrollment insurance is a data-rich and actionable actuarial environment for the mutual benefit of students, IHEs, insurers, data scientists, and governments.

### SUMMARY OF THE INVENTION

The present invention provides a tuition enrollment insurance system for institutions of higher education, the system. The system includes a data input interface configured to receive admissions information associated with a plurality of institutions from a constituent relationship management (CRM) system, demographic information associated with the plurality of intuitions from a student information system (SIS), and financial information associated with the plurality of institutions from one or more financial platforms. The system also includes a data transformation subsystem configured to transform the admissions information, financial information, and demographic information into a plurality of enrollment risk model indicator array inputs based on one or more file import protocol libraries and store the enrollment risk model indicator array inputs into a data science storage subsystem. The system further includes a plurality of enrollment risk structural equation models stored in memory configured to estimate enrollment risk, wherein each of the plurality of enrollment risk structural equation models includes a plurality of enrollment risk model indicator arrays. The system includes an enrollment risk model interface having an enrollment risk model processor configured to compute a plurality of different enrollment risks and estimates based on one of the plurality of enrollment risk structural equation models, wherein the enrollment risk model interface processor is configured to input the enrollment risk model indicator array inputs from the data science storage subsystem into the enrollment risk model indicator arrays associated with a selected enrollment risk structural equation model to compute an enrollment risk estimate based on the selected enrollment risk structural equation model, wherein the enrollment risk model interface processor is configured to store information associated with the enrollment risk estimate to a web application storage subsystem. The system includes a customer analytics interface having a customer analytics interface processor configured to provide visualizations of a plurality of different enrollment risks and estimates based on one of the plurality of enrollment risk structural equation models, wherein the customer analytics interface processor is configured to list available risk estimates and associated visualization parameters for user selection and plot interactive risk assessments based on same. The system includes a product selection interface having a product selection interface processor configured to recommend and accept product selections. The system includes a product and contracting interface having a product and contracting interface processor configured for contract configuration, wherein contract configuration includes providing a list of available product features and contract requirements, receiving authorization of related linked data feeds, configuring available options and compliance thresholds, and setting payment methodology and scheduling.

Another aspect of the present invention is generally directed to a method of providing tuition enrollment insurance for institutions of higher education. The method includes the steps of receiving admissions information associated with a plurality of institutions from a constituent relationship management (CRM) system, receiving demographic information associated with the plurality of intuitions from a student information system (SIS), receiving financial information associated with the plurality of institutions from one or more financial platforms, selecting an enrollment risk structural equation model to estimate enrollment risk, the enrollment risk structural equation model having a plurality of enrollment risk endogenous latent variables (hₖ) and a plurality of enrollment risk exogenous latent variables (xⱼ), wherein each of the plurality of enrollment risk endogenous latent variables and each of the plurality of enrollment risk exogenous latent variables have an associated enrollment risk model indicator array, wherein the plurality of enrollment risk endogenous latent variables and the plurality of enrollment risk exogenous latent variables are dependent upon one or more other enrollment risk endogenous latent variables and enrollment risk exogenous latent variables, transforming the admissions information, financial information, and demographic information into a plurality of enrollment risk model indicator array inputs, inputting the enrollment risk model indicator array inputs into the enrollment risk model indicator arrays associated with the plurality of enrollment risk endogenous latent variables and the plurality of enrollment risk exogenous latent variables, estimating direct and indirect indicator correlation with each of the plurality of endogenous latent variables and each of the of the plurality of exogenous latent variables, estimating enrollment risk based on the effects of the plurality of endogenous latent variables and the effects of the plurality of exogenous latent variables, and reporting the enrollment risk via a human machine interface.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 illustrates an exemplary higher education enrollment enterprise risk management (“HE3RM”) system in accordance with the present disclosure.

FIG. 2 illustrates an exemplary data intake subsystem for the HE3RM system of FIG. 1.

FIG. 3A illustrates an exemplary HE3RM statistical modeling subsystem of FIG. 1.

FIG. 3B illustrates an exemplary HE3RM structural equation model for use in conjunction with the HE3RM statistical modeling subsystem of FIG. 3A.

FIG. 3C illustrates another exemplary HE3RM structural equation model for use in conjunction with the HE3RM statistical modeling subsystem of FIG. 3A.

FIG. 3D illustrates an exemplary risk estimate database schema.

FIG. 4 illustrates an exemplary HE3RM risk visualization subsystem of FIG. 1.

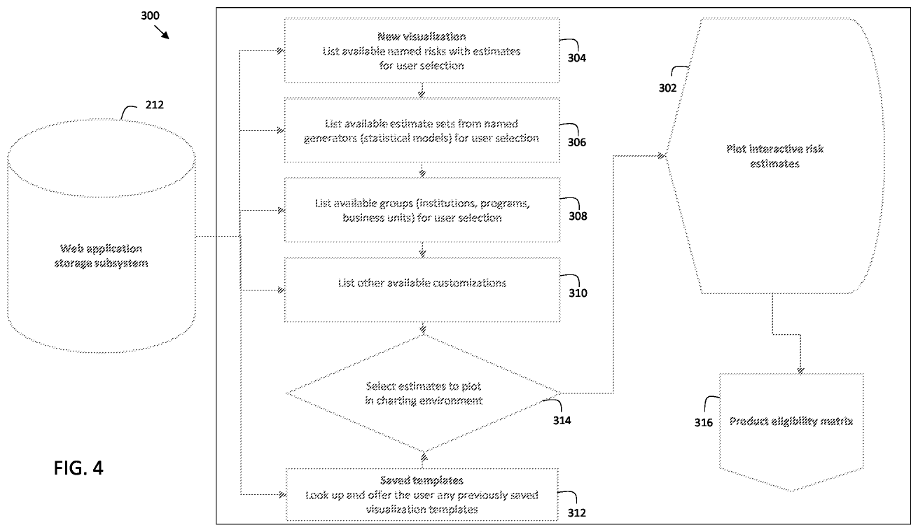

FIG. 5 illustrates an exemplary HE3RM product recommendation and selection subsystem of FIG. 1.

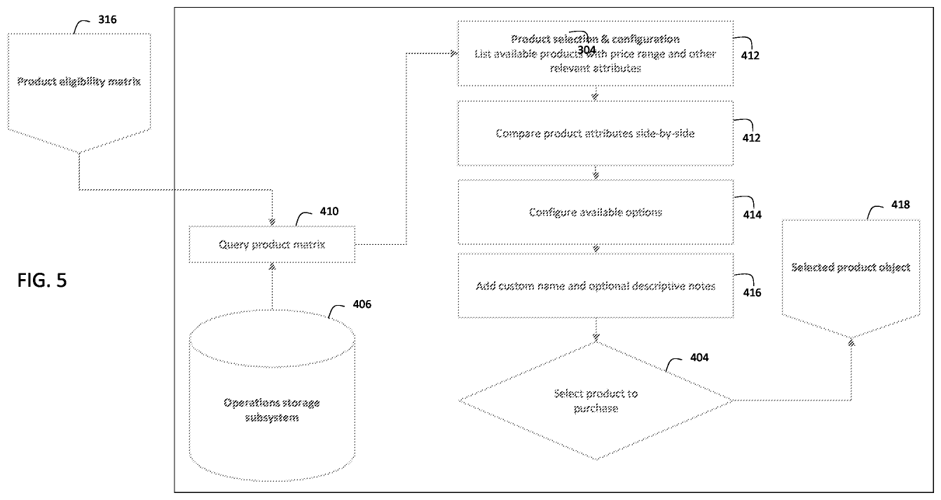

FIG. 6 illustrates an exemplary HE3RM contract customization and confirmation subsystem of FIG. 1.

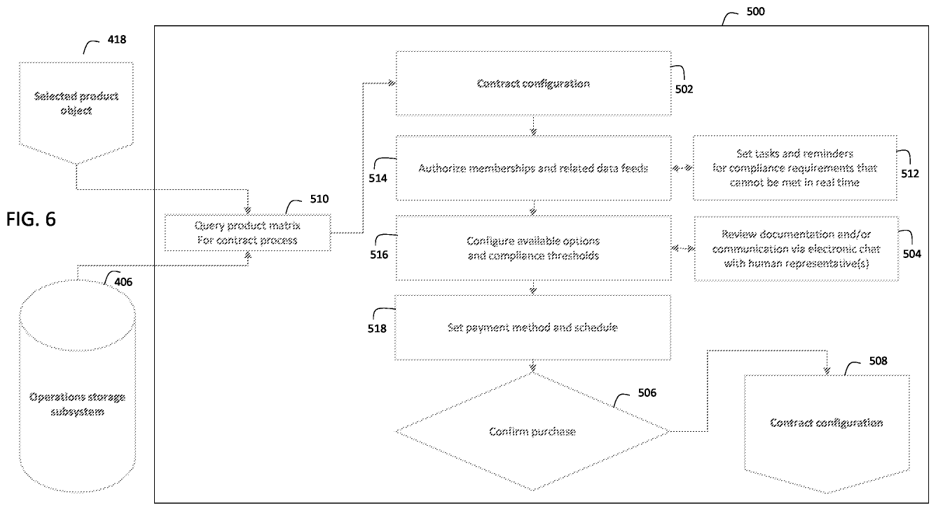

FIG. 7A illustrates an exemplary HE3RM monitoring and compliance visualization subsystem of FIG. 1.

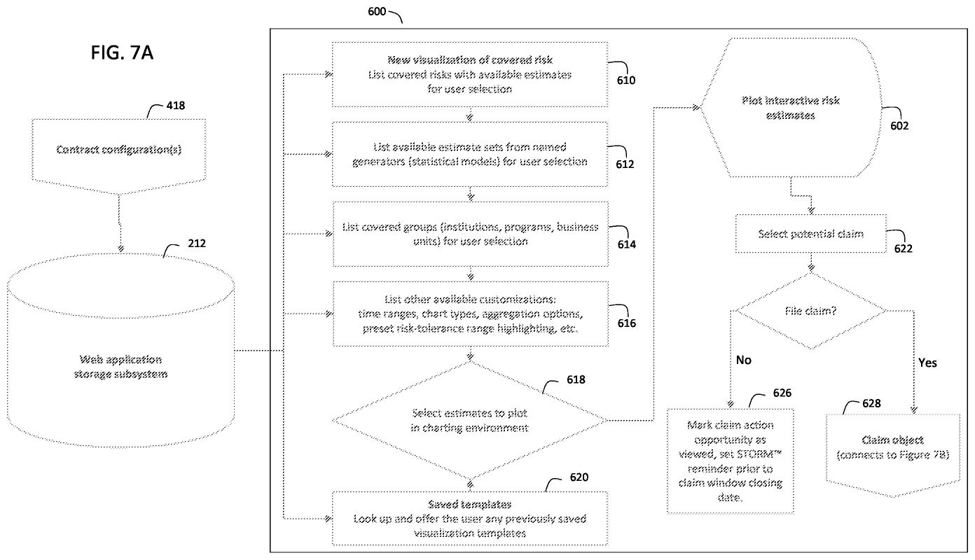

FIG. 7B illustrates an exemplary HE3RM claim subsystem of FIG. 1.

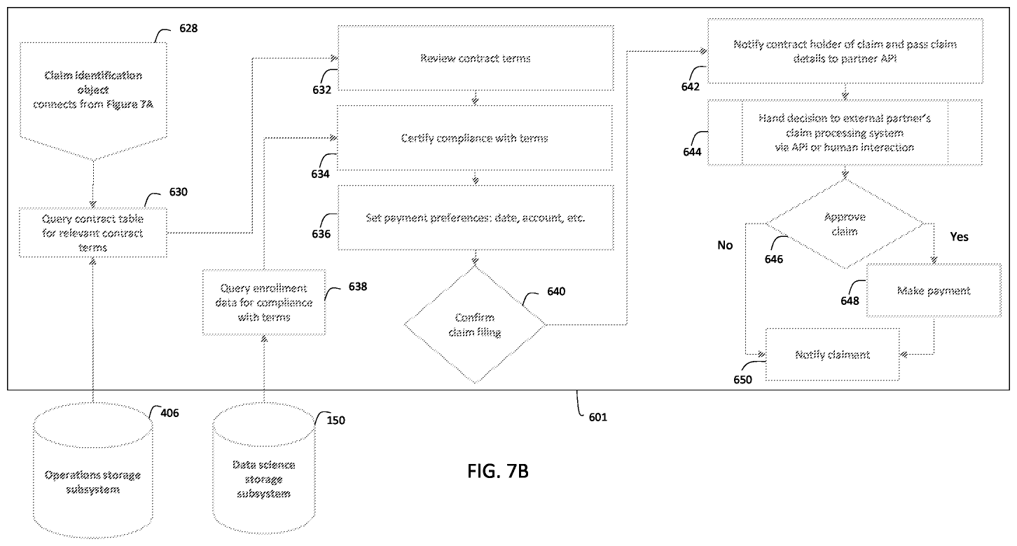

### DESCRIPTION OF THE CURRENT EMBODIMENT

The present disclosure is generally directed to systems and methods for higher education enrollment enterprise risk management (HE3RM). Embodiments of the present disclosure provide systems and methods for initializing, configuring, monitoring, and evaluating parametric tuition insurance in connection with institutions of higher education (IHEs). Systems and methods in accordance with the present disclosure can include software, models, schema, and other data stored in memory that operates in conjunction with an enterprise risk management (ERM) platform.

No current solution provides IHEs with tuition enrollment insurance. That is, no current systems or methods provide IHEs the ability to research, configure, purchase, monitor, and evaluate tuition enrollment insurance policies that hedge against certain events such as threshold declines in one or more of enrollment, retention, graduate success, fundraising, and endowment performance, to name a few exemplary events. The disclosed embodiments of the present disclosure provide such capabilities for enterprise risk management (ERM) systems of IHEs.

System and methods in accordance with the present disclosure provide an overarching system with a plurality of subsystems that cooperate to provide a tuition enrollment frontend and backend for setting up, managing, monitoring, and covering claims in a tuition enrollment insurance system utilizing enterprise risk management (“ERM”) tools. The systems and methods of the present disclosure provide a system configured to import data from various independent computer systems such as one or more of an enterprise risk management (ERM) system, a constituent relationship management (CRM) system, a student information systems (SIS), and a financial and actuarial analysis system.

The backend processor of the present disclosure can be configured to determine appropriate coverage levels for loss of net tuition revenue caused by enrollment decline, tuition discount rate increase, retention decline (attrition), and/or net donor revenue decline. The processor facilitates graphical and numerical identification of appropriate trigger points (“parameter values”) for insurance or financing for an institution based on a combination of internal and external data inputs. These inputs are synthesized statistically into analytics and visualizations that allow users to determine and then purchase desired coverage. One objective of enterprise risk management and financial risk reduction for these events is protecting endowment or other cash reserves against draw down beyond planned or benchmarked levels.

Risk Management Platform and Risk Management Software

The strategic organizational risk management (STORM™) platform, offered by RiskClimate, is one exemplary ERM software platform that can operate in conjunction with HE3RM. In general, STORM is a cloud-based software-as-a-service (SaaS) that facilitates access and use of an ERM framework by IHEs. STORM or another ERM platform can facilitate analyzing, monitoring, and mitigating risks across a risk landscape, e.g., including criminal activity on- and off campus; personnel misconduct; natural disaster; facilities defects; event security; hazardous materials; and other risks. STORM can track quantitative data, e.g., data relating to frequency, severity, and estimated cost in a systematically comparable fashion across disparate settings and circumstances, allowing ERM leaders and risk managers to make empirically-driven judgments about prioritization for risk mitigation and insurance purchasing.

STORM or another ERM platform can be configured to foster and exploit network effects as the platform scales, documenting risk patterns across multiple IHEs while masking the identity of source institutions from other users. STORM can allow users and data scientists to identify a wide variety of peer groups of IHEs that facilitate pooling data, benchmarking, and identification of best practices.

The higher education enrollment enterprise risk management (HE3RM) software of the present disclosure will be described within the context of the STORM platform throughout the disclosure for efficiency and to aid explanation. However, it should be understood that in alternative embodiments, HE3RM can be configured to work in conjunction with ERM platforms other than STORM.

HE3RM provides a complete ERM-plus-insurance-market system. With the HE3RM package enabled, the STORM platform can perform one or more of the following:
Contribute institutional enrollment data to a data store through integration with an enrollment-management software platforms (e.g., via communication with admissions and enrollment services).
Analyze past and projected enrollment trends and estimate prospective losses or gains.
Develop, implement, and monitor plans to mitigate enrollment-related risks, with a particular focus on creating a new financial market by providing insurers and financiers with the means to monitor, reduce, and prevent potential moral hazard in THE enrollment-related behavior.
Identify and specify the nature of enrollment risks for which an individual THE, university system, or coalition of IHEs desire to purchase insurance, particularly by identifying a parameter or threshold value for enrollment change that would trigger insurance coverage if surpassed (i.e. parametric enrollment insurance as described in more detail below).
Enable efficient and well-documented legal and financial transactions related to contracting for insurance; sharing enrollment data; making, evaluating, and paying or denying claims.
Generate systemic data that allows for new innovations and forms of cooperation in higher education, particularly seeking to enable innovations that might enable greater investment in opportunities for student populations with historically limited access to higher education.

The ERM-plus-insurance-market system provided by HE3RM provides parametric tuition insurance for IHEs. Parametric insurance generally refers to a type of insurance that covers the probability of a predefined event happening instead of indemnifying actual loss incurred. Parametric insurance agreements are agreements to make a payment upon the occurrence of a triggering event, and as such are detached from any underlying physical asset or piece of infrastructure. That is, parametric insurance generally involves (1) a triggering event; and (2) a pay-out mechanism. The insurance coverage is triggered if pre-defined event parameters are met or exceeded, measured by an objective parameter or index that is related to an insured's particular exposure. In conventional parametric insurance, the event could be an earthquake, tropical cyclone, or flood where the parameter or index is the magnitude, wind speed or precipitation respectively. The pay-out mechanism refers to a pre-agreed pay-out if the parameter or index threshold is reached or exceeded, regardless of actual physical loss sustained. For example, with a conventional parametric insurance arrangement, the pay-out mechanism may be USD 10 million if a magnitude 7.0 earthquake occurs in a defined geographical area, or USD 30 million if a category 5 tropical cyclone occurs in a defined area, or USD 50,000 for every millimetre of cumulative rainfall above a certain threshold. The threshold can be configured to align with risk tolerance.

Embodiments of the present disclosure provide a new type of parametric insurance, parametric enrollment insurance for IHEs. In general, the triggering event for parametric enrollment insurance is a substantial unexpected decrease in enrollment across the entire sector or in a particular student subpopulation, in a particular region or metro, or among a particular group or type of IHEs. The precise parameters and triggering values can vary depending on the application.

Objective measurement of the substantial unexpected decrease in enrollment can be achieved with the use of various statistics and modeling, such as an enrollment tuition insurance predefined structured equations model.

Moral hazards can pose an issue for systems and methods of parametric enrollment insurance. Moral hazard exists when knowledge of insurance coverage or another safeguard leads a covered person or institution to expect any mistakes or dereliction of duty on their part to be prevented by the safeguard or to impose costs on the insurer. Parametric enrollment insurance in accordance with the present disclosure can be configured to reduce or prevent moral hazards from affecting the parametric enrollment insurance trigger.

Insurers often seek concrete methods to reduce or eliminate moral hazard and thus to simplify actuarial calculations and reduce uncertainty about the correct pricing for insurance premiums. Parametric insurance offers a means to do this by defining the triggering event as something that is demonstrably beyond the control of insured people and institutions.

In the case of enrollment insurance, much of the work of preventing moral hazard can be done by definition of trigger events that are demonstrably beyond any control of the insured institution, such as a nationwide decrease in applications to US IHEs from Chinese students of twenty-five percent or more, or another similar metric beyond control of the insured institution.

However, some embodiment of parametric enrollment insurance may involve a trigger event directly related to their specific institutional risk exposure, such as a decline in enrollment largely confined to that specific institution, to a peer group of institutions, or to a specific school or academic program. In such cases, some trigger events might be relatively vulnerable to moral hazard. Enrollment management personnel could, consciously or unconsciously, perceive such insurance as a license to take risks in areas such as cutting effort and expenses in admissions staffing and direct mail communications.

The higher education enrollment enterprise risk management (HE3RM) software of the present disclosure can be configured to monitor enrollment behavior by insured IHEs, receiving data feeds from common industry enrollment constituent relationship management (CRM) systems, thus documenting IHE recruitment efforts and admissions volume. The HE3RM software, in accordance with the present disclosure, can be configured to analyze such data to estimate a suitable cost of parametric insurance.

For example, suppose an IHEs paramount concern is total enrollment of an MBA program with 150 current students. The program's success is considered central to the future viability of the entire business ecosystem, but it's not yet fully funded by endowment funds and lacks donor support, leaving it too vulnerable to short-term volatility in enrollment. The IHE might rule out cutting faculty and courses to respond to an enrollment contraction, since these cuts would undermine efforts to build a long-term institutional academic culture and reputation.

In this example, the institution might want to insure themselves for the full amount of expected net tuition revenue (NTR) for each unfilled student seat below 100 students. An insurer quoting this inquiry might include HE3RM monitoring as a condition of the insurance, with the IHE's data feed going to STORM. HE3RM monitoring might thus provide assurance to the insurer that the recruitment and retention efforts of the insured IHE remain above some minimum percentile for similar programs nationwide.

The risk-monitoring functions of HE3RM benefit from integration into the wider STORM platform, bringing familiar ERM practices and interfaces—forms, reports, data visualizations, and workflows—to bear on enrollment management, thus benefiting from broadening professionalization of IHE administrators in thinking statistically and strategically. By presenting HE3RM's particular focus on enrollment as part of STORM, a general-purpose, holistic, and networked ERM platform, the STORM-plus-HE3RM concept offers the potential for a virtuous cycle of monitoring, risk management, discovery of opportunity to improve, innovation, experimentation, and monitoring of new risks associated with new experiments.

HE3RM System

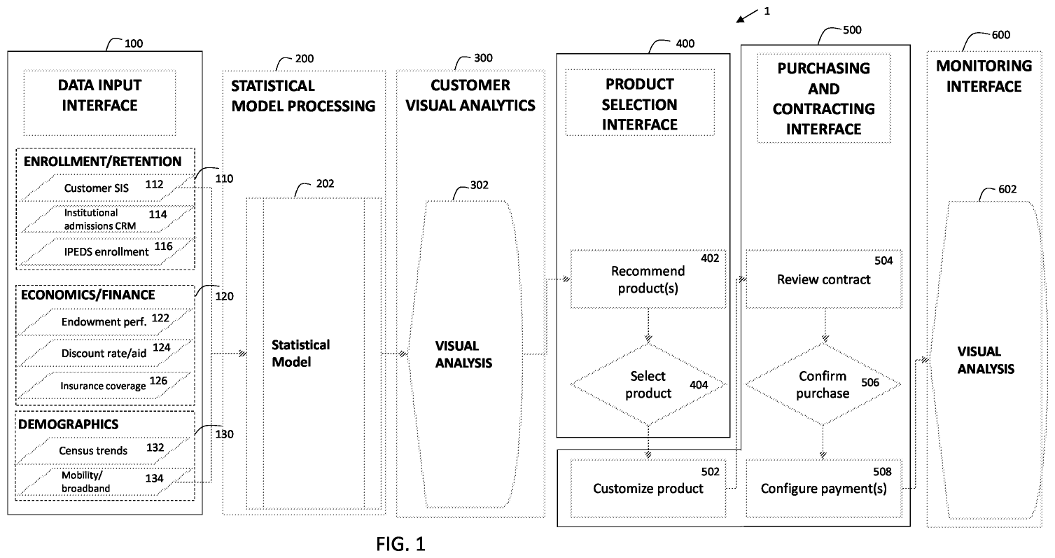

FIG. 1 illustrates an exemplary higher education enrollment enterprise risk management (“HE3RM”) system in accordance with the present disclosure and generally designated 1. The depicted embodiment includes six subsystems: a data input interface 100, one or more statistical models 200, a customer visual analytic subsystem 300, a product selection interface 400, a purchasing and contracting interface 500, and a monitoring interface 600. While the present embodiment includes these six subsystems, in alternative embodiments, additional, different, or fewer subsystems may be included in the HE3RM system in accordance with the present disclosure. Each of the exemplary subsystems will be discussed in more detail below.

Data Input Interface

The data input interface 100 of the HE3RM system enables efficient data provision. In the current embodiment, the HE3RM system can access or import data from a plurality of different sources including enrollment/retention data sources 110, economics/finance data sources 120, and demographics sources 130. In alternative embodiments, the HE3RM system can access or import data from additional, different, or fewer sources. In the current embodiment, the data sources are in network communication with the HE3RM system such that data can be selectively requested from the various data sources. The data sources can include data regarding a specific IHE, such as the specific subject IHE that is obtaining tuition enrollment insurance. The data sources can include data regarding a grouping of IHEs, such as national average IHE data or average data regarding a specific grouping of IHEs.

Enrollment/Retention Data Sources

The enrollment/retention data sources 110 can include various data sources that provide information regarding student enrollment and student retention. The enrollment/retention data sources can include various customer student information systems (SIS s) 112. For example, some common customer student information systems that can act as enrollment/retention data sources for the HE3RM system can include PeopleSoft, Ellucian, Workday, and Jenzabar to name a few. The enrollment/retention data sources can also include constituent relationship management (“CRM”) data sources 114 that provide information regarding institutional admissions. For example, some common institutional admission CRM systems from which HE3RM can import data can include Salesforce, Ellucian, and Slate to name a few exemplary data sources. The integrated postsecondary education data system (“IPEDS”) 116 is another enrollment/retention data source. IPEDS is a system of interrelated surveys conducted annually by the U.S. Department of Education's National Center for Education Statistics. IPEDS gathers information from colleges, universities, and technical and vocational institutions that participate in the federal student financial aid programs. The IPEDS data is generally available through the IPEDS Data Center at https://nces.ed.gov/Ipeds/use-the-data/survey-components. The IPEDS data includes basic information collected from institutions that do not have an open-admissions policy on the undergraduate selection process for first-time, degree/certificate-seeking students. This includes information about admissions considerations, admissions yields, and SAT and ACT test scores. The IPEDS data also includes data regarding enrollment patterns including data regarding Fall enrollment, residence of first-time students, age data, unduplicated 12-month head count data, instructional activity data, and number of incoming student data.

Economics/Finance Data Sources

The economics/finance data sources 120 can include various data sources that provide information regarding economics and financial information regarding the subject IHE that is being insured as well as other IHEs. One exemplary data source is a data source that can provide institutional endowment investment performance and withdrawal rate 122 information. Another exemplary economic/finance data source is a data source that can provide information regarding institutional tuition discount rate 124, financial aid offers, net tuition revenue, or other related information. Another exemplary economic/finance data source is an insurance coverage data source 126 that can provide information regarding insurance coverage (e.g., policy details), covered events, premiums, and claim amounts.

Demographics Data Sources

The demographics data sources 130 can include various data sources that provide information regarding IHE demographics. The demographics data sources 130 can include, for example, a government data source, such as the US Census Bureau trends on population grown and movement 132 and a data source associated with population mobility rates and access to broadband internet 134.

Data Transformation Subsystem

The data intake subsystem 100 can include a data transformation subsystem 140 that can transform data from the various data sources. The data transformation subsystem 140 can include an application programming interface 142 for direct machine-to-machined data connections. The data transformation subsystem 140 can also include various file import protocol libraries 144, such as CSV, google, JSON, SPSS, XLSX, to name a few. The data transformation subsystem 140 can convert various information into a suitable format for storage in a data science storage subsystem 150.

Statistical Model Processing

The statistical model processing subsystem 200 can process data from the data science storage subsystem to provide a tuition insurance model. In the depicted embodiment, the statistical model processing subsystem 200 lists the available statistical models for selection via an interface (e.g., a web interface or API) 206. Upon selection of a model, a list of available risks can be provided for selection via the interface 208. From the interface, a user can select a statistical/predictive model for the system to run. Based upon that selection, the statistical model processing subsystem can estimate the selected model 202 based on the selection 210 and the filtered applicable data 204 fed to indicator array in the model estimation subsystem. Examples will be discussed in more detail below. The output of the estimated selected model 202 can be stored in a web application storage subsystem. For example, the coefficient estimates for future reference by system operators can be stored.

SEM Estimators of Enrollment Risk

HE3RM provides a standardized infrastructure for statistical estimation. Though many statistical estimators can be employed for actuarial purposes, the HE3RM package focuses on structural equation modeling (SEM), a sophisticated statistical estimation methodology widely used in the social sciences, including psychology, sociology, economics, and political science. The method is particularly useful for estimating endogenous relationships, where variables may be causally interdependent, with each of two or more concepts causing the other(s) to some degree. SEM models can be sufficiently “identified”—that is, include enough exogenous variables that are not estimated as dependent on other variables—in order to provide “converge” on a unique best-fit solution set of parameter estimates for each of the relationships estimated in the model.

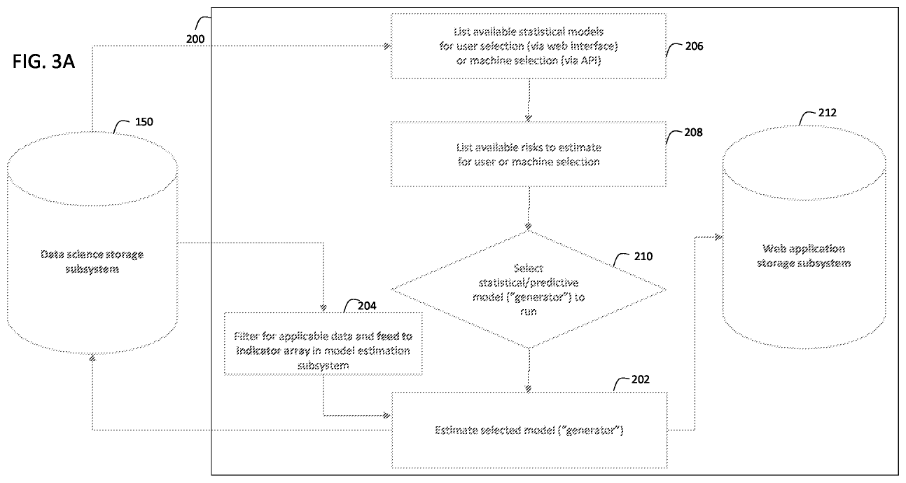

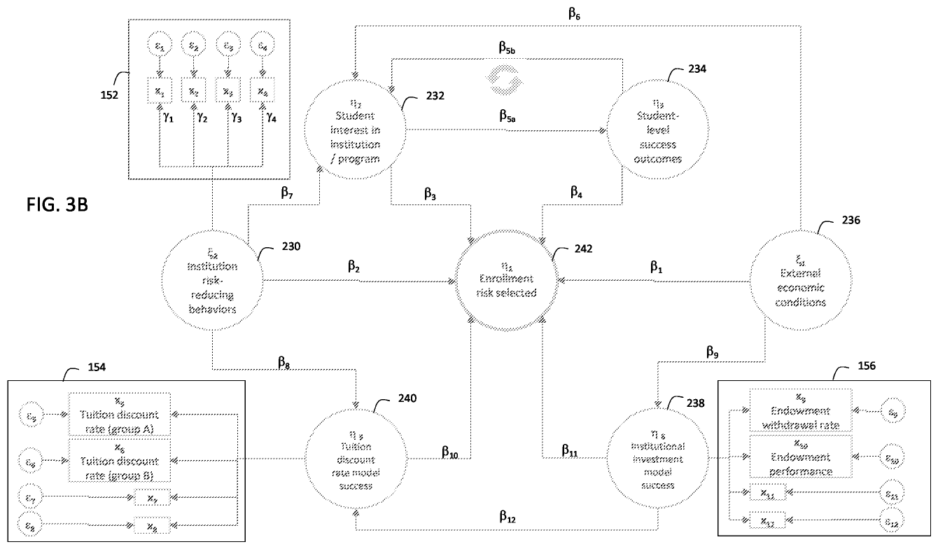

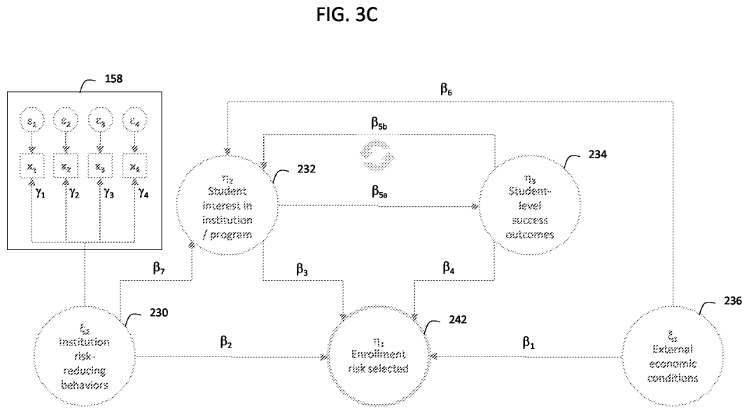

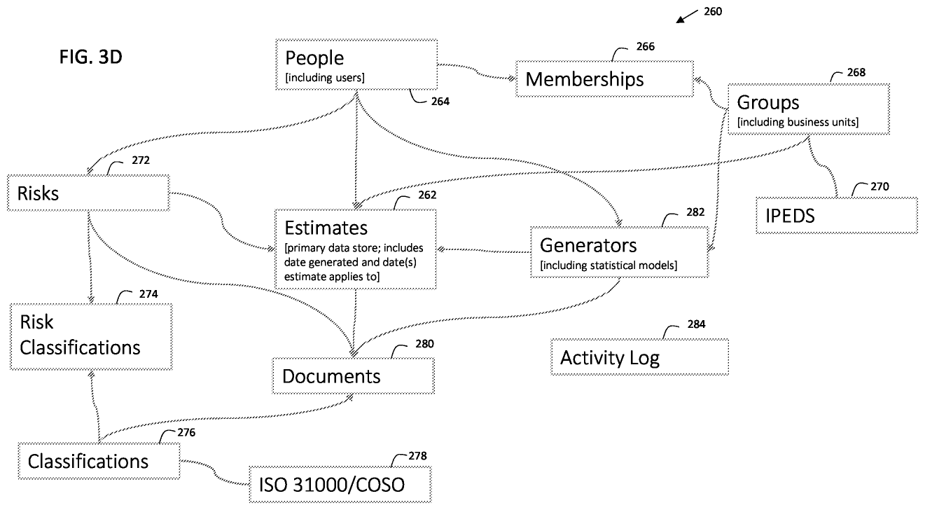

The models shown in FIGS. 3B and 3C include latent (i.e., unobserved) variables represented by circles and observed variables represented by rectangular shapes. Latent variables are named concepts measured as a function of covariation in those observed variables that are assigned to be indicators of that concept. Observed variables are columns of data present in the HE3RM data store, such as tuition discount rates on record in STORM from databases of higher education institutions and, where available, subunits (e.g., campuses, schools, and academic programs). By convention, latent variables are considered to be underlying influences that “cause” the indicators in each indicator array to take on their observed values.

Endogenous (i.e., dependent) latent variables are designated by the Greek letter eta with a subscript (ηₖ), while exogenous (i.e., independent) latent variables that are not modeled as affected by other variables in the model are designated with a Greek (ξⱼ).

Each indicator draws its data from a column of data in a table the HE3RM data repository (See 150 in FIG. 3A). Each table contains a row per institution per season and many columns of data for many attributes and measures that can serve as indicators.

Structural equation modeling (SEM) refers to a statistical estimation methodology widely used in the social sciences, including psychology, sociology, economics, and political science. The method can be particularly useful for estimating endogenous relationships, where variables may be causally interdependent, with each of two or more concepts causing the other(s) to some degree. SEM models should be sufficiently identified—that is, include enough exogenous variables that are not estimated as dependent on other variables—in order to converge by discovering a unique best-fit solution set of parameter estimates for each of the relationships in the model. While the present disclosure focuses on the use of structural equation modeling as the statistical estimation methodology for estimating the risks associated with tuition enrollment insurance, in alternative embodiments other forms of statistical estimation can be utilized instead of or in a supplementary fashion.

Exemplary SEM models are depicted in FIGS. 3B and 3C and discussed in more detail below. These SEM models include latent (i.e., unobserved) variables represented by circles and observed variables represented by rectangles. Latent variables refer to concepts measured as a function of covariation in assigned observed variables that are indicators for that concept. Observed variables generally refer to columns of data present in memory, such as a HE3RM data store. Observed variables can include tuition discount rates stored in memory, for example available from a database. By convention, latent variables are generally considered to be underlying influences that cause or influence the indicators to take on their observed values.

Selected Enrollment Risk

Referring to FIGS. 3B and 3C, the selected enrollment risk 242 can be a primary variable of interest for actuarial purposes and measures comparable enrollment performance outcomes across all the institutions in the large-N SEM statistical model. For example, a simple operational implementation can employ a single indicator: the percent of desired students enrolled past the final drop-out deadline after which full tuition payment is obligatory. In the current system configuration, institutions outperforming their goals can score more than 100%, underperformers less than 100%. In a parametric tuition insurance model in accordance with the present disclosure, an insured IHE falling below a particular threshold (e.g., 80% of goal) can be compensated using an incremental payout offering an agreed amount per tenth of a percent below the threshold, contingent upon monitoring evidence that the underperformance was not due to a moral hazard (e.g., institutional negligence).

One goal of an SEM model is to improve actuarial confidence by quantifying the contribution of the other latent and extant variables in the model to the selected risk. In one example, the model estimates coefficients (designated with the Greek letter beta, (3, in FIGS. 3B and 3C) that quantify the contribution of other factors to percent of goal achieved. The system can output information related to how much institutional risk-reducing behaviors (e.g., effort) contribute to risk, net of external influences, such as the state of the economy, and internal influences, such as endowment investment policy. The more influential these behaviors are in the model, the greater the risk that moral hazard may motivate the insured to take unusual risks and underperform because they are insured.

Running an SEM model also provides a point estimate and uncertainty distribution for each included IHE's selected enrollment risk, allowing segmentation of the IHE market into low- and high-risk segments and follow-up case study analysis of outliers whose estimated risk is wide of the expected value. Most such factors can be idiosyncratic and resistant to modeling, but outlier studies can identify previously overlooked systemic risk factors that can improve the accuracy of future models and inform enrollment ERM practice at IHEs.

Indicator Arrays

For visual simplicity, FIGS. 3B and 3C do not depict indicator arrays for every latent variable. However, each latent variable has a set of relevant observed indicators depending on the particular model selected. Below various examples of indicators for each indicator array are described for a number of different latent variables for the two exemplary SEM models shown in FIGS. 3B and 3C.

Institution Risk-Reducing Behaviors

The latent variable institution risk-reducing behaviors 230 in FIG. 3B, designated ξ₂ in statistical notation, quantifies the amount of effort the institution is allocating to achieving enrollment goals and thus reducing the risk of enrollment decline. The latent variable is associated with indicator array 152, which can include a number of indicators (x₁ to x₄). Although the exemplary model visualization of FIG. 3B only includes four indicators, in alternative embodiments additional, fewer, or different indicators may be associated with the latent variable. For example, any such indicator array might contain a dozen or more indicators associated with a particular latent variable. Specific indicators can depend on a variety of different factors, such as data feasibility and availability, but candidate indicators for the institution risk-reducing behaviors 230 latent variable can include:
Total institutional expenditures on enrollment recruitment and retention activities per desired student head count.
Institutional representatives' number of personal touchpoints per prospect per season.
The total number of years of relevant experience of current admissions personnel per desired student head count.
The existence (1) or non-existence (0) of a loss-prevention program designed to escalate cases of high-desirability applicants showing signs of indecision.
The ratio of identified prospects to total desired applicants; higher ratios indicate greater effort to reach prospects.
Long-term (say, 5-year) trend in IHE ranking for academic quality, as a proxy for investment in basic product quality and delivery.
The quality of THE recruitment communications and mail pieces as rated by an independent observer on a 7-point scale from “Inferior” to “Superior.”

When the model is operated or processed, the coefficients on these indicators (designated γ₁ to γ₄ in FIG. 3B) indicate how well the indicators serve as proxies for the underlying risk-reduction concept; indicators that are poor proxies can be dropped, simplifying the model and reducing the reporting load on IHEs.

The estimate of coefficient β₂ reveal how responsive the selected enrollment risk is to institutional effort; if the coefficient is small, then the selected enrollment risk may be primarily a function of factors beyond IHE control, and the risk of moral hazard is fairly small; if β₂ is large, then institutions have significant leverage and the risk of moral hazard is correspondingly high, and monitoring of institutional inputs and outputs can be integrated into the overarching system and method to protect insurers.

Student Interest in Institution (or Program)

The latent variable student interest in institution/program 232 in FIG. 3B and designated 112 in statistical notation measures how disposed prospective students are to pay attention to a given IHE's outreach. For some prestigious institutions, various communications they send will inspire eager consumption and discussion in pre-collegiate households; for low-name-recognition schools, mass mailings and other communications may be less effective. This latent variable can also be identified by an indicator array (not shown), that can include indicators such as:
Average prospective students' response rate to early-stage institutional recruitment mailings (responses received divided by mailings sent). This indicator space depends on good IHE use of web analytics technology; under certain circumstances, it can be disaggregated into an array of separate figures for postal mailings, email solicitations, text messages, phone calls, to name a few. Higher-than-average response rates can indicate greater-than-average student interest.
IHE mention rate per 1 million tweets among target demographics of prospective students and, where relevant their parents.
Sentiment toward the IHE in social media and other scrapable public comment contexts.
The volume of unsolicited organic inquiries to the institution.
Ranking of the institution by prospective students participating in third-party surveys.

Running the SEM model quantifies how responsive student interest is to institutional risk-reducing behaviors through coefficient β₂, and coefficient β₃ provides an estimate of the effects of student interest on the selected enrollment risk; together, these two coefficients estimate the indirect effect of institutional effort on the selected enrollment risk mediated through student interest. If β₇ is small, institutional effort contributes little to student interest; if β₇ is large and β₃ is also large, prospective student interest is a mediator of the effects of institutional risk-reducing behaviors, even if the direct effect estimated by coefficient β₂ is small. In other words, in this scenario, increased institutional effort above the norm has little value if it doesn't pique student interest.

For example, an operator or data scientist may test a hypothesis about enrollment by running the model twice, once for a selected enrollment risk (η₁) for domestic students (η_{1d}) and again for a selected enrollment risk for international students (ηₜᵢ). One hypothesis may be that a) domestic enrollment is an information-rich environment in which student interest is largely based in familial and regional loyalties, and enrollment is almost exclusively a function of the relative quality of institutional execution, while b) international enrollment is an information-poor environment in which student interest is highly sensitive to institutional effort. If the hypothesis is supported, β₇ will be small in the domestic model and large in the international model. If β₃ is also large in the international student model, then student interest is an important mediating factor, and the model will improve the accuracy of actuarial estimates for parametric insurance against downturns in international student enrollment.

Student-Level Success Outcomes

The latent variable student-level success outcomes 234 in FIG. 3B, designated 113 in statistical notation, measures how well students are faring in academics and career outcomes at the IHEs in the model. The variable is identified by an indicator array (not shown). Candidate indicators for this array can include:
Percent of entering students continuing into their second year (short-term retention).
Percent of current students reporting intent to complete their degree in third-party surveys.
Percent of entering students completing a degree.
Percent of alumni reporting five-year post-graduation earnings at or above the median for 4-year graduates.
Percent of alumni engaged in the IHEs donation and recruitment programs (long-term retention).

Running the SEM model quantifies how responsive student success is to student interest through coefficient β₅ₐ, and vice-versa through coefficient β_{5b}; the first part of this reciprocal relationship (β₅ₐ) reflects the expectation that IHEs with higher levels of student interest will enjoy higher levels of commitment to stay enrolled and finish degrees, while those with lower interest will be more vulnerable to attrition. Meanwhile, the second part (β_{5b}) reflects the expectation that better student outcomes can be observed by prospective students whose interest in the IHE will be stimulated. Thus, the effect can be estimated of student success on the selected enrollment risk (η₁) as mediated through student interest (η₂).

Finally, coefficient β₄ measures the direct effect of student-level success outcomes (η₃) on the selected enrollment risk (η₁); this relationship reflects the hypothesis that student success has direct effects on many enrollment risks of interest, especially various retention measures; this indicator array must be carefully designed to ensure that it remains conceptually distinct from the selected enrollment risk.

External Economic Conditions

The latent variable student-level success outcomes 236 in FIG. 3B, designated ξ₁ in statistical notation, measures how well students are faring in academics and career outcomes at the IHEs in the model. The exogenous latent variable (meaning it is not itself modeled as a function of other latent variables in the model) can be identified by an indicator array (not shown). Candidate indicators for this array can include:
Percent annual GDP growth (or decline) in the IHE's metro or region.
Stock market performance over the previous twelve months.
Consumer Price Index (CPI) for college tuition.
Unemployment rate in the IHE's metro or region.
Average consumer debt levels.
Ranking of the IHE's metro as a desirable place to live.

Estimating the SEM model returns an estimate of the coefficient (β₁) for the effect of external economic conditions (ξ₁) on the selected enrollment risk (η₁). The sign on the estimate for this coefficient (positive or negative) can vary depending on the selected enrollment risk. On one hand, economic downturns reduce income available to pay tuition; on the other hand, high unemployment can drive learners to pursue degree completion while waiting for the job market to improve.

This latent variable and its indicator array can assist in assuring insured IHEs that they won't be penalized by insurers using HE3RM to monitor moral hazard risk for underperforming enrollment expectations due to economic conditions beyond their control.

The model results can also provide insurers with actuarial insight for pricing parametric insurance for enrollment risks that are especially sensitive to general economic conditions. For example, suppose that the selected enrollment risk being modeled for insurability were defined as the percentage of students paying full tuition. If the estimated value of β₁ is large, insurers might conclude that the desired insurance is best understood as a standard-issue hedge against general economic volatility and offer a product with corresponding financial attributes. On the other hand, if the estimated value of β₁ is small or zero, insurers might calculate that the selected risk is generally unrelated to economic conditions and that premiums can be reduced given diligent IHE application of ERM best practices and moral hazard monitoring.

Differentiating Models

The model in FIG. 3B demonstrates the modularity and generalizability of the HE3RM system by differing from FIG. 3C in the inclusion of two additional latent variables at the bottom of the diagram. Eta-five is a latent variable measured by combining observable indicators of institutions' tuition discount rate model 240, while eta-six is a latent variable measured by combining observable indicators of institutions' investment performance 238. The indicator array for the IHE tuition discount rate model 240 can include the various tuition discount rate indicators for various groups of institutions. The indicator array for the IHE investment model success 238 can include an indicator array 156 with indicators such as endowment withdrawal rate and endowment performance.

Even in a mature data environment, these additional indicator arrays may not be available for all institutions, so the reduced-form model in FIG. 3C illustrates the flexibility to introduce an alternate, simplified statistical model specification. This interchangeability can be standardized such that the FIG. 3B or FIG. 3C model (or another model) can be utilized in connection with the HE3RM system.

The HE3RM system thus provides a standardized machine data interface and a standardized human user interface that together allow selection and estimation of many statistical, algorithmic, and machine-learning models using data elements common to enrollment risk management, insurance, and monitoring.

Risk Estimate Schema

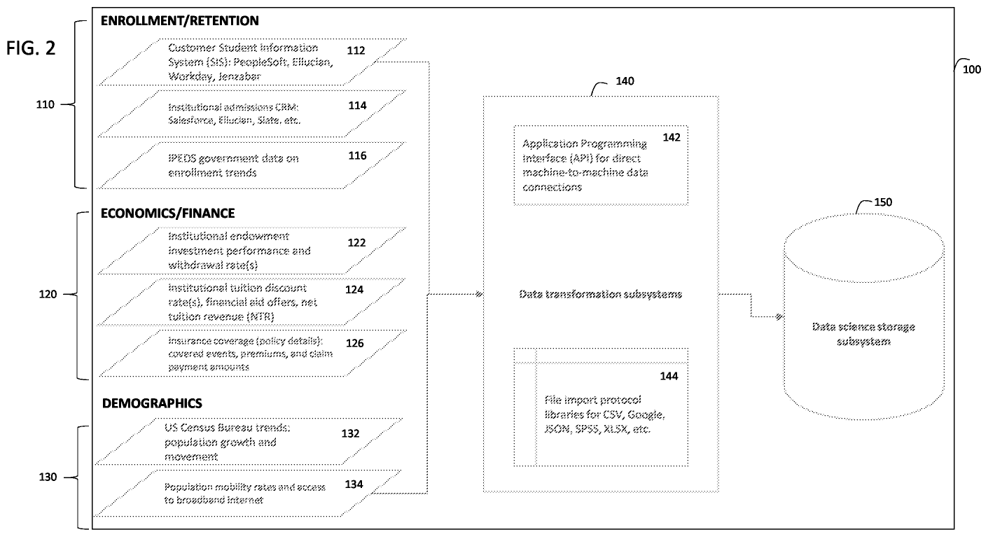

FIG. 3D illustrates an exemplary risk estimate database schema 260. The risk estimate database schema provides a representation of a tuition enrollment insurance model. The schema can be stored in memory, e.g., in the data science storage subsystem 150 shown in FIG. 2. Arrowheads in the schema represent one to many relationships. The schema outlines the various relationships between information. For example, in the exemplary schema depicted in FIG. 3D, People 264 are associated in a one to many relationship with risks, 272, estimates, 262, generators 282 and memberships 266. The estimates 262 can be stored in memory in data store and can include associated information such as the date generated and the relevant dates to which the estimate(s) apply. The generators 282 can refer to the specific statistical model(s) that generated the estimates 262. In some instances, multiple statistical models may influence the particular estimates 262. Groups, such as business units 268 can be associated with memberships 266, generators 282, and IPEDS 270. The risks stored in memory 272 can be associated with one or more risk classifications 274 and one or more documents 280. The estimates 262 and generators/models 282 can also be associated with one or more documents. The documents 280 and 274 may be associated with classifications 276, which can be derived from a standard, such as ISO 31000/COSO 278. The schema may also include an activity log 284.

Visual Analytic Subsystem

The system 1 can include a risk visualization subsystem 300 that provides an interface for providing interactive risk estimates. The risk visualization subsystem 300 can draw from a web application storage system 212 or another storage system accessible by the system 1. In an exemplary embodiment, one estimate row is provided in the storage system 212 per named risk per model per time period. This aligns with the exemplary data model schema 260 illustrated in FIG. 3D.

In operation, a new visualization can be selected using the risk visualization subsystem 300. One exemplary implementation of the process can begin with the system 300 providing a list of risks for user selection 304. A list of available estimate sets associated with the selected risk selection can be presented for user selection 306 and a list of available groups (e.g., institutions, programs, business units) can also be presented for user selection 308. Various other visualization customization options can also be presented to the user, such as, time ranges, chart types, aggregation options, preset risk-tolerance range highlighting, to name a few 310. Rather than making selections each time a visualization is to be generated, saved templates can be utilized 312. In some embodiments, a set of saved risk visualization templates can be presented to the user for selection.

Based on the user's selection (e.g., individual selections or risk visualization template), the risk visualization subsystem can select estimates to plot in a charting environment 314. A plotting module can be utilized to plot interactive risk estimates 302 based on the selections along with the input data and model(s). The interactions available from the plotting module can vary from application to application, but suffice it to say in some embodiments, the plotting module can permit highlighting high-cost outcomes as well as numerical and graphical selection of risk range to insure or hedge against. From the interactive risk estimates 302 presented to the user, an interface can be provided that provides information regarding a product eligibility matrix 316. For example, the product eligibility matrix and include parameter values saved to memory that cooperate with the product selection interface, e.g., by listing available product offerings in that interface, which will be described in more detail next.

Product Selection Subsystem

The product selection interface 400 can accept a product eligibility matrix (e.g., one generated from the risk visualization subsystem 300) and facilitate product selection. In operation, the various saved parameters associated with a product eligibility matrix 316 can be utilized to query 410 a product matrix from an operation storage subsystem 406. Once queried, the product selection interface 400 can be configured to list available products with price range another relevant attributes 412, the product selection interface can provide user interface elements for comparing product attributes side-by-side 412 and configuring available options 414. The product selection interface 400 can also be configured to permit the addition of custom names and optional descriptive notes 416. From the product selection user interface, an operator can select a product to purchase 404, which can be stored in memory as a selected product object 418.

Purchasing and Contracting Subsystem

The contract customization and confirmation subsystem 500 facilitates contract configuration and customization. The selected product object 418 can be provided by the product selection interface 400 and used to query 510 the product matrix from the operations storage subsystem 406. The contract customization subsystem 500 can provide a list of available product features and contract requirements to the operator in a contract configuration interface 502. The user interface can provide user interface elements to permit authorization of memberships and access to linked data feeds 514. The enterprise risk management system can be configured to set tasks and reminders for compliance requirements that cannot be met in real time 512. The user interface of the contract customization subsystem 500 can also provide user interface elements for configuring available options and compliance thresholds 516. The user interface elements can facilitate the review of documentation and/or communication via electronic communication with a human representative 504. The subsystem 500 can also facilitate the setting of a payment method and schedule 518 and permit confirmation of the purchase of the tuition enrollment insurance 506 outputting a specific contract configuration that can be stored to memory 508

Monitoring and Compliance Subsystem

A monitoring and compliance subsystem 600 can monitor contract compliance to identify tuition enrollment insurance claims as well as provide an interface for claim approval. The contract configuration 418 and associated details can be stored in a storage subsystem 212. For example, one estimate row can be provided per named risk per model per time period according to a risk estimate schema (e.g., as depicted in FIG. 3D). A visualization of covered risk can be provided by the monitoring subsystem 600. The visualization can include a list of covered risks with available estimates that can be available for user selection and interaction 610. Available risk estimate sets from named models/generators can also be provided for user selection 612 along with lists of covered groups (e.g., institutions, programs, business units) for user selection 614. The visualization can also provide other configuration options such as time ranges, chart types, aggregation options, and preset risk tolerance range highlighting, to name a few. These visualization options can essentially track with the same visualization options provided during the initial tuition enrollment selection process. Saved templates can be utilized to look up and offer the user any previously saved visualization templates 620. The selected estimates can be plotted in a charting environment 618 and an interactive risk estimate plot can be output by the system for interaction by the user 602.

The monitoring and compliance subsystem user interface elements can permit selection of a tuition enrollment insurance claim 622 and the ability for the user to file the claim for automatic submission 628 as a claim object into the claim system 601 which will be discussed in more detail below. Alternatively, the potential claim can be marked as a claim action opportunity as viewed, and a reminder can be set to review the claim prior to a window closing date 626.

The monitoring and compliance subsystem 600 can also include a claim submission subsystem 601. A claim identification object 628 can be utilized to query a contract table for relevant contract terms 630 from the operations storage subsystem 406. The claims subsystem can facilitate review of contract terms 632, for example by presenting the contract terms to the user on a display or via electronic communication to a user device. The claims subsystem 601 can include user interface elements for certifying compliance with the tuition enrollment contract terms 634 and for setting payment terms and preferences, such as date and account. The claims subsystem 601 can provide user interface elements for confirming the filing of a claim 640, notifying the contract holder of the claim passing along details to a partner application programming interface 642. The claim decision can be communicated to an external partner claim processing subsystem via an application programming interface or human interaction. The system 600 can receive a claim approval decision 646. If the decision is approved, the subsystem can facilitate claim payment 648 or if the decision is not approved, the subsystem can notify the claimant 650.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A tuition enrollment insurance system for institutions of higher education, the system comprising:
a data input interface configured to receive admissions information associated with a plurality of institutions from a constituent relationship management (CRM) system, demographic information associated with the plurality of intuitions from a student information system (SIS), and financial information associated with the plurality of institutions from one or more financial platforms;
a data transformation subsystem configured to transform the admissions information, financial information, and demographic information into a plurality of enrollment risk model indicator array inputs based on one or more file import protocol libraries and store the enrollment risk model indicator array inputs into a data science storage subsystem;
a plurality of enrollment risk structural equation models stored in memory configured to estimate enrollment risk, wherein each of the plurality of enrollment risk structural equation models includes a plurality of enrollment risk model indicator arrays;
an enrollment risk model interface having an enrollment risk model processor configured to compute a plurality of different enrollment risks and estimates based on one of the plurality of enrollment risk structural equation models, wherein the enrollment risk model interface processor is configured to input the enrollment risk model indicator array inputs from the data science storage subsystem into the enrollment risk model indicator arrays associated with a selected enrollment risk structural equation model to compute an enrollment risk estimate based on the selected enrollment risk structural equation model, wherein the enrollment risk model interface processor is configured to store information associated with the enrollment risk estimate to a web application storage subsystem;
a customer analytics interface having a customer analytics interface processor configured to provide visualizations of a plurality of different enrollment risks and estimates based on one of the plurality of enrollment risk structural equation models, wherein the customer analytics interface processor is configured to list available risk estimates and associated visualization parameters for user selection and plot interactive risk assessments based on same;
a product selection interface having a product selection interface processor configured to recommend and accept product selections;
a product and contracting interface having a product and contracting interface processor configured for contract configuration, wherein contract configuration includes providing a list of available product features and contract requirements, receiving authorization of related linked data feeds, configuring available options and compliance thresholds, and setting payment methodology and scheduling.

2. The tuition enrollment insurance system of claim 1 wherein the enrollment risk structural equation model includes a plurality of variables including an institution risk-reducing behavior risk variable, a student interest variable, student-level success outcome variable, and an external economic condition variable.

3. The tuition enrollment insurance system of claim 1 wherein the enrollment risk structural equation model includes a plurality of indicator arrays each having a plurality of indicators, wherein each of the plurality of indicator arrays are associated with one of a plurality of latent variables.

4. The tuition enrollment insurance system of claim 3 wherein one of the plurality of latent variables is institution risk-reducing behaviors and the indicators include two or more of total institutional expenditures on enrollment recruitment and retention activities per desired student head count, institutional representatives' number of personal touchpoints per prospect per season, total number of years of relevant experience of current admissions personnel per desired student head count, existence (1) or non-existence (0) of a loss-prevention program designed to escalate cases of high-desirability applicants showing signs of indecision, ratio of identified prospects to total desired applicants; higher ratios indicate greater effort to reach prospects, trend in IHE ranking for academic quality, as a proxy for investment in basic product quality and delivery, an rated quality of IHE recruitment communication.

5. The tuition enrollment insurance system of claim 3 wherein one of the plurality of latent variables is student interest in institution and the associated indicators include two or more of average prospective students' response rate to early-stage institutional recruitment mailings, IHE mention rate per tweets among target demographics of prospective students, volume of unsolicited organic inquiries to the institution, and ranking of the institution by prospective students participating in third-party surveys.

6. The tuition enrollment insurance system of claim 3 wherein one of the plurality of latent variables is student-level success outcome and the associated indicators include two or more of percent of entering students continuing into their second year, percent of current students reporting intent to complete their degree in third-party surveys, percent of entering students completing a degree, percent of alumni reporting five-year post-graduation earnings at or above the median for 4-year graduates, and percent of alumni engaged in the IHEs donation and recruitment programs (long-term retention).

7. The tuition enrollment insurance system of claim 3 wherein one of the plurality of latent variables is external economic conditions and the associated indicators include two or more of percent annual GDP growth (or decline) in the IHE's metro or region, stock market performance over the previous twelve months, Consumer Price Index (CPI) for college tuition, unemployment rate in the IHE's metro or region, average consumer debt levels, and ranking of the IHE's metro as a desirable place to live.

8. The tuition enrollment insurance system of claim 1 wherein the contract configuration includes a plurality of parametric triggers for tuition enrollment insurance.

9. The tuition enrollment insurance system of claim 1 including a monitoring subsystem configured to monitor enrollment behavior by insured IHEs based upon data feeds from industry enrollment constituent relationship management (CRM) systems.

10. A method of providing tuition enrollment insurance for institutions of higher education, the method comprising:
receiving admissions information associated with a plurality of institutions from a constituent relationship management (CRM) system;
receiving demographic information associated with the plurality of intuitions from a student information system (SIS);
receiving financial information associated with the plurality of institutions from one or more financial platforms;
selecting an enrollment risk structural equation model to estimate enrollment risk, the enrollment risk structural equation model having a plurality of enrollment risk endogenous latent variables (hₖ) and a plurality of enrollment risk exogenous latent variables (xⱼ), wherein each of the plurality of enrollment risk endogenous latent variables and each of the plurality of enrollment risk exogenous latent variables have an associated enrollment risk model indicator array, wherein the plurality of enrollment risk endogenous latent variables and the plurality of enrollment risk exogenous latent variables are dependent upon one or more other enrollment risk endogenous latent variables and enrollment risk exogenous latent variables;
transforming the admissions information, financial information, and demographic information into a plurality of enrollment risk model indicator array inputs;
inputting the enrollment risk model indicator array inputs into the enrollment risk model indicator arrays associated with the plurality of enrollment risk endogenous latent variables and the plurality of enrollment risk exogenous latent variables;
estimating direct and indirect indicator correlation with each of the plurality of endogenous latent variables and each of the of the plurality of exogenous latent variables;
estimating enrollment risk based on the effects of the plurality of endogenous latent variables and the effects of the plurality of exogenous latent variables;
reporting the enrollment risk via a human machine interface.

11. The method of providing tuition enrollment insurance of claim 10 wherein the plurality of enrollment risk endogenous latent variables (hₖ) and the plurality of enrollment risk exogenous latent variables (xⱼ) include two or more of an institution risk-reducing behavior risk variable, a student interest variable, student-level success outcome variable, and an external economic condition variable.

12. The method of providing tuition enrollment insurance of claim 10 wherein the plurality of indicator arrays each having a plurality of indicators, wherein each of the plurality of indicator arrays are associated with at least one of the plurality of latent variables or at least one of the plurality of endogenous variables.

13. The method of providing tuition enrollment insurance of claim 12 wherein one of the plurality of variables is institution risk-reducing behaviors and the indicators include two or more of total institutional expenditures on enrollment recruitment and retention activities per desired student head count, institutional representatives' number of personal touchpoints per prospect per season, total number of years of relevant experience of current admissions personnel per desired student head count, existence (1) or non-existence (0) of a loss-prevention program designed to escalate cases of high-desirability applicants showing signs of indecision, ratio of identified prospects to total desired applicants; higher ratios indicate greater effort to reach prospects, trend in IHE ranking for academic quality, as a proxy for investment in basic product quality and delivery, an rated quality of IHE recruitment communication.

14. The method of providing tuition enrollment insurance of claim 12 wherein one of the plurality of variables is student interest in institution and the associated indicators include two or more of average prospective students' response rate to early-stage institutional recruitment mailings, IHE mention rate per tweets among target demographics of prospective students, volume of unsolicited organic inquiries to the institution, and ranking of the institution by prospective students participating in third-party surveys.

15. The method of providing tuition enrollment insurance of claim 12 wherein one of the plurality of variables is student-level success outcome and the associated indicators include two or more of percent of entering students continuing into their second year, percent of current students reporting intent to complete their degree in third-party surveys, percent of entering students completing a degree, percent of alumni reporting five-year post-graduation earnings at or above the median for 4-year graduates, and percent of alumni engaged in the IHEs donation and recruitment programs (long-term retention).

16. The method of providing tuition enrollment insurance of claim 12 wherein one of the plurality of variables is external economic conditions and the associated indicators include two or more of percent annual GDP growth (or decline) in the IHE's metro or region, stock market performance over the previous twelve months, Consumer Price Index (CPI) for college tuition, unemployment rate in the IHE's metro or region, average consumer debt levels, and ranking of the IHE's metro as a desirable place to live.

17. The method of providing tuition enrollment insurance of claim 10 wherein the plurality of variables include two or more of intuition risk-reducing behaviors, tuition discount rate model success, institutional model success, external economic conditions, student-level success outcomes, and student interest in institution.

18. The method of providing tuition enrollment insurance of claim 10 including identification of parameter triggers for providing tuition enrollment insurance.

19. The method of providing tuition enrollment insurance of claim 10 including monitoring enrollment behavior by insured IHEs based upon data feeds from industry enrollment constituent relationship management (CRM) systems.

20. The method of providing tuition enrollment insurance of claim 10 including determining whether moral hazard risk is above a threshold level.
